(19) United States
(12) Patent Application Publication
(10) Pub. No.: US 2026/0219057 A1
(43) Pub. Date: Jul. 30, 2026

(54) SYSTEMS AND METHODS FOR PROVIDING REAL-TIME ROUTE VIEWS

(71) Applicant: Toyota Jidosha Kabushiki Kaisha, Aichi-ken (JP)

(72) Inventors: Anat Litan Sever, Sunnyvale, CA (US); Alexander Granieri, Mountain View, CA (US)

(73) Assignee: Toyota Jidosha Kabushiki Kaisha, Aichi-ken (JP)

(21) Appl. No.: 19/039,101

(22) Filed: Jan. 28, 2025

(51) Int. Cl. G01C 21/36

(52) U.S. Cl. CPC G01C 21/3602; G01C 21/3617; G01C 21/3629; G01C 21/3647; B60K 35/00; B60K 35/20; B60K 2360/164; G01C 21/265; G01C 21/28; G01C 21/34; G01C 21/36; G01C 21/3644

(57) ABSTRACT

A system for providing real-time route views includes a user device computer and a server computer in electronic communication. The user device computer is programmed to identify a potential navigation route. The user device computer is programmed to transmit a request for real-time images captured along the potential navigation route to the server computer. The user device computer is programmed to receive one or more real-time images from the server computer. The user device computer is programmed to display the one or more received real-time images. The server computer is programmed to, in response to receiving the request for real-time images captured along the potential navigation route from the user device computer, collect one or more real-time images along the potential navigation route. The server computer is programmed to transmit the one or more captured real-time images to the user device computer.

### TECHNICAL FIELD

The present specification generally relates to apparatuses and methods for providing real-time route views, and, more specifically to apparatuses and methods for providing real-time route views of a potential navigation route.

### BACKGROUND

Many vehicles and smart phones include navigation systems, such as Global Positioning Systems (GPS), that store or access digital maps. These systems may generate potential navigation routes, e.g., from a location to a destination, and may display the potential navigation routes to a user of the systems, e.g., as a highlighted paths along a displayed map. The user may select one of the potential navigation routes, e.g., for guidance in navigating to the destination.

### SUMMARY

In one embodiment, a system for providing real-time route views includes a user device computer and a server computer in electronic communication with the user device computer. The user device computer is programmed to identify a potential navigation route. The user device computer is programmed to transmit a request for real-time images captured along the potential navigation route to the server computer. The user device computer is programmed to receive one or more real-time images from the server computer. The user device computer is programmed to display the one or more received real-time images. The server computer is programmed to, in response to receiving the request for real-time images captured along the potential navigation route from the user device computer, collect one or more real-time images along the potential navigation route. The server computer is programmed to transmit the one or more captured real-time images to the user device computer.

In another embodiment, a user device for providing real-time route views includes a computer having a processor and a memory storing machine-readable instructions executable by the processor. The machine-readable instructions include instructions to identify a potential navigation route. The machine-readable instructions include instructions to transmit a request for real-time images captured along the potential navigation route. The machine-readable instructions include instructions to receive one or more real-time images captured along the potential navigation route. The machine-readable instructions include instructions to display the one or more received real-time images.

In yet another embodiment, a method for providing real-time route view includes identifying a potential navigation route. The method includes transmitting a request for real-time images captured along the potential navigation route. The method includes receiving one or more real-time images captured along the potential navigation route. The method includes displaying the one or more received real-time images.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a block diagram of a system for providing real-time route views, according to one or more embodiments shown and described herein;

FIG. 2 schematically depicts a flow chart of a process for providing real-time route views with the system of FIG. 1, according to one or more embodiments shown and described herein; and

FIG. 3 schematically depicts a user device for the system of FIG. 1, the user device displaying the real-time images captured along a proposed navigation route, according to one or more embodiments shown and described herein.

### DETAILED DESCRIPTION

Embodiments described herein are directed to a system and method for providing real-time route views along a potential navigation route. The system generally includes a user device computer and a server computer programmed to identify the potential navigation route and request, receive, and display one or more real-time images captured along the potential navigation route. Various embodiments of the system and method are described in more detail herein. Whenever possible, the same reference numerals will be used throughout the drawings to refer to the same or like parts.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

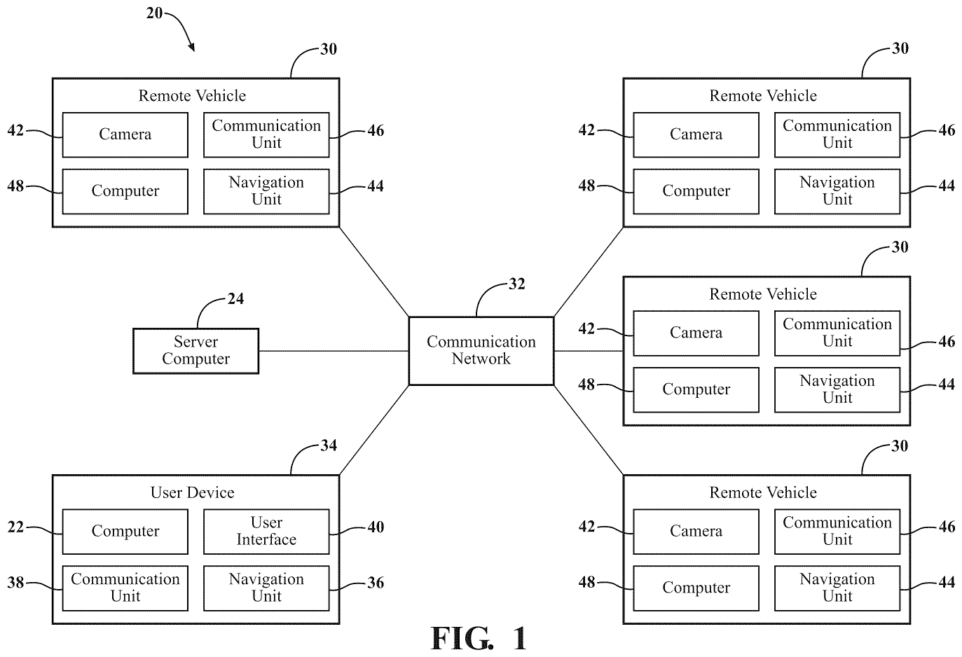

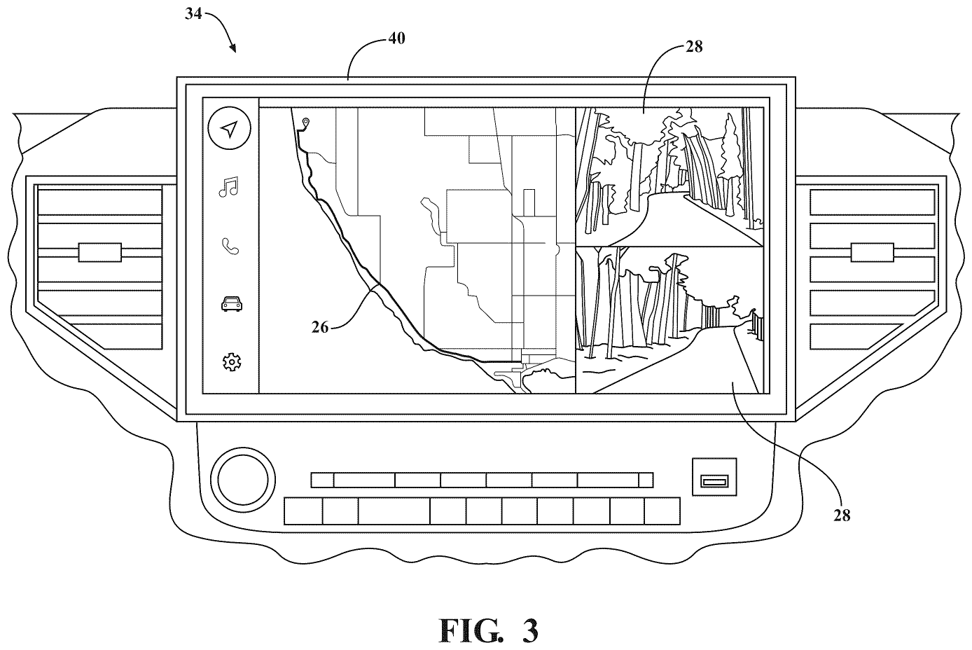

Referring now to FIG. 1, a system 20 for providing real-time route views is schematically illustrated according to one or more embodiments described herein. The system 20 may generally include a user device computer 22 and a server computer 24 in electronic communication with the user device computer 22. The user device computer 22 may be programmed to identify a potential navigation route 26 (schematically shown if FIG. 3). The user device computer 22 may be programmed to transmit a request for real-time images 28 (also schematically shown if FIG. 3) captured along the potential navigation route 26 to the server computer 24. The server computer 24 may be programmed to capture one or more real-time images 28 along the potential navigation route 26 in response to receiving the request for real-time images 28 from the user device computer 22. The server computer 24 may be programmed to transmit the one or more captured real-time images 28 to the user device computer 22. The user device computer 22 may be programmed to receive one or more real-time images 28 from the server computer 24. The user device computer 22 may be programmed to display the one or more received real-time images 28.

A potential navigation route 26 is one possible route along streets, roads, highways, and the like along which a vehicle may be navigated. The potential navigation route 26 specifies certain segments of streets, highways, roads and the like, e.g., that lead to a certain destination, that traverse a certain geographic area, etc. The potential navigation route 26 may include information specifying a direction of travel, e.g., north, south, east, west, etc., along the various segments of the potential navigation route 26.

Multiple potential navigation routes 26 may exist. Such potential navigation routes 26 may have characteristics unique to each other. For example, and without limitation, one potential navigation route 26 may be a shortest distance to a destination, another potential navigation route 26 may be estimated as requiring a least amount of time to reach the destination, another potential navigation route 26 may pass by certain points of interest (e.g., historical landmarks, geographic overlooks, etc.), another potential navigation route 26 may avoid certain types of roads (e.g., such route being free of highway and expressway segments), another potential navigation route 26 may navigate only through areas that have a population density or traffic density that is below a threshold, etc.

A real-time image 28 is a still image or series of images, e.g., video, that is captured generally contemporaneously with its display and/or a request for such real-time image 28. A displayed still image or video may be consider a real-time image 28 when such still image or video was captured within a short threshold amount of time before being displayed. For example, and without limitation, a displayed still image or video that was displayed with 5 minutes of being captured. A displayed still image or video may considered a real-time image 28 when such still image or video was captured after being requested, i.e., such still image or video was not pre-stored in advance of being requested.

Capturing real-time images 28 along a potential navigation route 26 enables a user that receives such images 28 to view what could be seen in real-time along the potential navigation route 26, with the user then better able to better determine whether they would like to travel the potential navigation route 26. The real-time images 28 captured along the potential navigation may indicate to the user that the potential navigation route 26 is desirable to the user. For example, the user may decide if the potential navigation route 26 is sufficiently scenic enough for the user to forgo traveling a less scenic, abet faster, other potential navigation route 26.

### Communication Network

A communication network 32 can be included in the system 20 to facilitate electronic communication, e.g., between the user device computer 22, the server computer 24, the one or more remote vehicles 30, one or more infrastructure cameras (not shown), etc., positioned along the potential navigation route 26. The communication network 32 can include, but is not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. The communication network 32 can have any suitable communication range associated therewith and can include, for example, global networks (e.g., the Internet), metropolitan area networks (MANs), wide area networks (WANs), local area networks (LANs), or personal area networks (PANs). In addition, the communication network 32 can include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

### User Device

The system 20 may include a user device 34 that is operable by the user to perform the various functions described herein. Example user devices 34 include, but are not limited to smart phones and tablets, personal computers, vehicle navigation and infotainment systems, and the like.

The user device 34 may include the user device computer 22, a navigation unit 36, a communication unit 38, and/or one or more user interfaces 40. The navigation unit 36, the communication unit 38, and/or the one or more user interfaces 40 may be communicatively coupled to the user device computer 22, e.g., via wired and/or wireless electronic communication structure, including, but not limited to, a communication bus, a controller area network (CAN) bus, local interconnect network (LIN) bus, or the like. As used herein, the term “communicatively coupled” means that coupled components are capable of exchanging data signals with one another such as, for example, electrical signals via conductive medium, electromagnetic signals via air, optical signals via optical waveguides, and the like.

The user device computer 22 may be any device or combination of components comprising a processor and non-transitory computer readable memory. The processor may be any device capable of executing the machine-readable instruction set stored in the non-transitory computer readable memory. Accordingly, the processor may be an electric controller, an integrated circuit, a microchip, a computer, or any other computing device.

The non-transitory computer readable memory may comprise RAM, ROM, flash memories, hard drives, or any non-transitory memory device capable of storing machine-readable instructions such that the machine-readable instructions can be accessed and executed by the processor. The machine-readable instruction set may comprise logic or algorithm(s) written in any programming language of any generation (e.g., 1GL, 2GL, 3GL, 4GL, or 5GL) such as, for example, machine language that may be directly executed by the processor 132, or assembly language, object-oriented programming (OOP), scripting languages, microcode, etc., that may be compiled or assembled into machine readable instructions and stored in the non-transitory computer readable memory. Alternatively, the machine-readable instruction set may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components.

The navigation unit 36 is capable of generating location information and/or heading information indicative of a location of the user device 34 by receiving one or more GPS signals from one or more GPS satellites. The navigation unit 36 may include a GPS device, electronic compass, or the like communicatively coupled to the user device computer 22 of the user device 34. The navigation unit 36 may be configured to generate heading information, for example, based on an electronic compass. The GPS signal communicated to the user device computer 22 may include location information comprising a National Marine Electronics Association (NMEA) message, a latitude and longitude data set, a street address, a name of a known location based on a location database, or the like. Additionally, the navigation unit 36 may be interchangeable with any other systems capable of generating an output indicative of a location. For example, a local positioning system that provides a location based on cellular signals and broadcast towers or a wireless signal detection device capable of triangulating a location by way of wireless signals received from one or more wireless signal antennas.

The navigation unit 36 may include a digital map that includes geographical information. The digital map may be dynamic in that the geographical information contained therein is capable of being updated. The digital database may be stored locally (i.e. a local digital map stored on memory of the navigation unit 36) or may be uploaded from a remote location (i.e. a cloud-based digital map that the navigation unit 36 is in communication with) such that the geographical information is temporal and is updated pursuant to the geographical information stored by the cloud-based digital map, the server computer 24 or the like in communication with the navigation unit 36.

The communication unit 38 may communicatively couple the user device 34 to the communication network 32. The communication unit 38 may include, for example, and without limitation, an antenna, a modem, LAN port, Wi-Fi card, WiMax card, Bluetooth hardware, IrDA hardware, Wireless USB hardware, Z-Wave hardware, ZigBee hardware, mobile communications hardware, near-field communication hardware, satellite communication hardware, cellular network communication hardware, and/or any wired or wireless hardware for communicating with other networks and/or devices. The cellular network may include, for example, and without limitation, a Global System for Mobile Communications (GSM) network, a 3G Universal Mobile Telecommunications System (UMTS) network, a 4G Long Term Evolution (LTE) network, a 5G network, and the like.

The user interfaces 40 enable a user to interact with the user device 34. The user interfaces 40 may include one or more input devices that allow a user to input information to the user device computer 22. For example, and without limitation, the input device may be a keyboard, a mouse, a joystick, a touch screen, a remote control, a pointing device, a video input device, an audio input device, a haptic feedback device, and/or the like. The user interfaces 40 may include one or more output devices that allow a user to receive information from the user device computer 22. For example, and without limitation, the output device may be a display, a speaker, and/or the like. The display may include any medium capable of transmitting an optical output such as, for example, a cathode ray tube, light emitting diodes, a liquid crystal display, a plasma display, or the like. Moreover, the display may be a touchscreen that, in addition to providing optical information, detects the presence and location of a tactile input upon a surface of or adjacent to the display.

The user device computer 22 may be programmed to, i.e., the memory may store machine-readable instructions executable by the processor to, identify one or more potential navigation routes 26. The user device computer 22 may identify multiple, e.g., a second, a third, etc., potential navigation routes 26. Each of the potential navigation routes 26 may have characteristics that overlap and characteristics that are unique relative to each other. For example, one potential navigation route 26 may avoid freeways and navigate along a coast to a destination, and another potential navigation route 26 may avoid freeways and navigate through a wooded area to the destination.

The user device computer 22 may be programmed to identify the potential navigation routes 26 based on a user preference. A user preference may include information specifying one or more of an end destination, an intermediary destination, a type of road to travel and/or avoid, a desired population and/or traffic density, one or more desired visual characteristics (e.g., certain plant, landscape, points of interest, landmarks, etc.), a level of urgency in reaching a destination (e.g., get there as soon as possible, within a certain amount of time, or not urgent), and the like.

A user may provide one or more user preferences to the user device computer 22 via one or more of the user interfaces 40. For example, the user may provide tactile input to a touch screen, audio input to a microphone, actuation input with a button, etc. The input may indicate one or more preferences of the user. For example, the user may select from among a plurality of preferences displayed on the touch screen, type one or more user preferences into a keyboard displayed on the touchscreen or other text input device, provide a verbal instruction that includes one or more user preferences, or otherwise interact with the user interface 40 to indicate user preferences. In response to such user input, the user interface 40 may transmit, and the user device computer 22 may receive, information specifying the user preferences input by the user.

The user device computer 22 may determine one or more user preferences in cooperation with the server computer 24. The user device computer 22 may determine one or more user preferences, for example and without limitation, based on calendar data, based on location data, based on information gleaned from emails, smartphone applications, websites, and the like, based on historical data, based on traffic data, based on data received from the server computer 24, etc., including conventional techniques to identify potential navigation routes 26 and user preferences.

The user device computer 22 may identify one or more potential navigation routes 26 in response to a user request that includes one or more user preferences, e.g., as received from one or more of the user interfaces 40. The user device computer 22 may utilize a large language model (LLM) and machine learning (ML) to receive the user request and identify one or more potential navigation routes 26. For example, the user device computer 22 may receive a user request from the user input device as an audio command in natural language. Such command may be, for example and without limitation, “Assistant, how do I get from point A to point B with the most beautiful blooming views? I'm not in a hurry now, but prefer a less winding road and see many flowers.” The user device computer 22 may, e.g., in cooperation with the server computer 24 and using conventional techniques, analyze such command with LLM and ML to identify the destination point B, certain user preferences, such as rural roads that are generally free of curves and that traverse through geographical areas that could contain flowers.

The user device computer 22 may be programmed to transmit a request for real-time images 28 captured along the one or more of the identified potential navigation routes 26, e.g., a request for real-time images 28 along a first potential navigation route 26, another request for real-time images 28 along a second potential navigation route 26, etc. The user device computer 22 may transmit the request for real-time images 28, for example, to the server computer 24 and via the communication network 32. The server computer 24 may receive the request for real-time images 28 and transmit the request for real-time images 28 to one or more remote vehicles 30, one or more infrastructure cameras, etc., positioned along the potential navigation routes 26, e.g., as further discussed below. The request for real-time images 28 may specify the potential navigation routes 26, including a direction of travel along the potential navigation routes 26. The direction of travel along the navigation route that is a direction that is traveled along a segment of the potential navigation route 26 when following, i.e., navigating, the potential navigation route 26, e.g., north, south, east, west, etc. Specifying the direction of travel along the potential navigation route 26 permits capture of real-time images 28 that better replicate images that could be encountered when traveling along the potential navigation route 26. The user device computer 22 may transmit the request for real-time images 28 after identifying the potential navigation routes 26, and/or the user device computer 22 may transmit the request for real-time images 28 in response to an input to the user interface 40 by a user, e.g., as further discussed below.

Infrastructure cameras are generally fixed in place and can capture and transmit images, e.g., in response to receiving a request. Infrastructure cameras generally include a camera, e.g., as describe below for cameras 42, and a communication unit, e.g., as described herein for the communication unit 38, 46. Infrastructure cameras may include computers to facility operation of the camera and the communication unit. Infrastructure cameras may be fixed to, for example and without limitation, buildings, posts, bridges, etc. Example infrastructure cameras include traffic cameras, security cameras, doorbell cameras, etc.

The user device computer 22 may be programmed to receive one or more real-time images 28 captured along the potential navigation route 26, e.g., by one or more remote vehicles 30, one or more infrastructure cameras, etc., positioned along the first potential navigation route 26, the second potential navigation route 26, etc., and traveling and/or facing in the direction of travel of the respective potential navigation route 26. For example, the user device 34 may receive the real-time images 28 via the communication network 32. The real-time images 28 may be received from, e.g., the server computer 24 acting as an intermediary between the user device 34 and the one or more remote vehicles 30, one or more infrastructure cameras, etc., positioned along the potential navigation route 26. The received real-time images 28 may include information specifying a location and direction of travel and/or facing direction of capture, e.g., along the potential navigation route 26. The received real-time images 28 may include information regarding one or more objects identified in the real-time images 28. The objects may be identified by the user device computer 22 and/or the server computer 24, as discussed below.

The user device computer 22 may be programmed to identify one or more objects in the real-time images 28. The user device computer 22 may identify one or more objects by utilizing, for example, and without limitation, a feature descriptor algorithm or an image descriptor algorithm, such as scale-invariant feature transform (“SIFT”), speeded up robust feature (“SURF”), histogram of oriented gradients (“HOG”), generalized search tree (“GIST”), fast retina keypoint (“FREAK”), and binary robust invariant scalable keypoints (“BRISK”), and the like. The user device computer 22 may identify the objects as, e.g., a certain type of plant, a certain landmark or geographic feature, a certain building or architectural structure, a pedestrian, a vehicle, etc. The user device computer 22 may identify the one or more objects in cooperation with the server computer 24.

The one or more identified objects may relate to one or more of the user preferences. In other words, the one or more identified objects may be categorically associated with one or more of the user preferences. For example, the identified object may be a certain type of plant, a certain landmark, or a certain geographic feature when the user preference indicates the user would prefer a scenic route.

The user device computer 22 may be programmed to display the one or more received real-time images 28. To display the real-time images 28, the user device computer 22 may transmit information specifying the still images and/or video of the real-time images 28 to a display screen, such as a touch-screen display, of the user interface 40. The user interface 40 may display the still images and/or video of the real-time images 28 upon receiving such information. The user device computer 22 may display real-time images 28 captured along multiple potential navigation routes 26, e.g., real-time images 28 captured the first potential navigation route 26, real-time images 28 captured the second potential navigation route 26, etc.

The user device computer 22 may be programmed to present information regarding the identified objects. The computer may present information regarding the identified objects concurrent with displaying the one or more received real-time images 28. For example, the user device computer 22 may audibly present the information regarding the identified object via speakers of the user interface 40 while the real-time image 28 including the object is visually provided on the display of the user interface 40. As another example, the computer may visually present the information regarding the identified object via speakers of the user interface 40, e.g., as a text overlay on the real-time image 28 including the object and provided on the display of the user interface 40. The user device computer 22 may collect the information regarding the identified objects for one or more computers remote from the user device 34, such as the server computer 24. The user device 34 may utilize artificial intelligence, e.g., ChatGPT, OpenAI, Claude, Google Gemini, Microsoft Copilot, Perplexit or the like, to collect the information regarding the identified objects. The information regarding the identified object may relate to one or more of the user preferences. For example, and without limitation, the when the user preference indicates the user would prefer views of flowers, the information regarding the identified object may be a color, a name, and/or a blooming stage of an identified flower in the real-time image 28.

The user device computer 22 may be programmed to request selection of the first potential navigation route 26, the second potential navigation route 26, etc. The user device computer 22 may transmit the request to one or more of the user interfaces 40. For example, and without limitation, the user device computer 22 may command a speaker to output audio that requests user input on whether the first potential navigation route 26, the second potential navigation route 26, etc., are acceptable to a user of the user device 34. As another example, the user device computer 22 may command an electronic display to visually project a request for user input on whether the first potential navigation route 26, the second potential navigation route 26, etc., are acceptable to a user of the user device 34.

The user device computer 22 is further programmed to receive a user input indicating acceptance of one of the potential navigation routes 26, e.g., after displaying the received real-time images 28 captured along the potential navigation routes 26. The user may provide the user input by interacting with the user interface 40, e.g., pressing a button, touching a touch screen in a certain location, providing an audible command, etc.

The user device computer 22 is further programmed to navigate the accepted navigation route, e.g., from a current position of the user device 34 as determined by the navigation unit 36. The user device computer 22 may navigate the accepted navigation route, for example, by actuating a display of the user interface 40 to provide a map and visual guidance indicating how to proceed along the accepted navigation route and/or by actuating speakers of the user interface 40 to provide audible turn-by-turn directions. As another example, the user device computer 22 may provide instructions to an autonomous vehicle system indicating the accepted navigation route, e.g., when the user device 34 is integrated with, or otherwise connected to, an autonomous vehicle. The user device computer 22 may navigate the accepted navigation route in response to receiving the user input.

### Server Computer

The server computer 24 may be any device or combination of components comprising a processor and non-transitory computer readable memory. The processor may be any device capable of executing the machine-readable instruction set stored in the non-transitory computer readable memory. Accordingly, the processor may be an electric controller, an integrated circuit, a microchip, a computer, or any other computing device. While the embodiment depicted in FIG. 1 includes a single computer, other embodiments may include more than one computer communicatively coupled to each other.

The non-transitory computer readable memory may comprise RAM, ROM, flash memories, hard drives, or any non-transitory memory device capable of storing machine-readable instructions such that the machine-readable instructions can be accessed and executed by the processor. The machine-readable instruction set may comprise logic or algorithm(s) written in any programming language of any generation (e.g., 1GL, 2GL, 3GL, 4GL, or 5GL) such as, for example, machine language that may be directly executed by the processor 132, or assembly language, object-oriented programming (OOP), scripting languages, microcode, etc., that may be compiled or assembled into machine readable instructions and stored in the non-transitory computer readable memory. Alternatively, the machine-readable instruction set may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components.

The server computer 24 may include, for example, and without limitation, an antenna, a modem, LAN port, Wi-Fi card, WiMax card, mobile communications hardware, near-field communication hardware, satellite communication hardware and/or any wired or wireless hardware for communicating with other networks and/or devices. The server computer 24 may be in communication with the user device computer 22 of the user device 34 and with one or more remote vehicles 30, one or more infrastructure cameras, etc., e.g., via the communication network 32.

The server computer 24 may be programmed to, i.e., the memory of the server computer 24 stores machine-readable instructions executable by the processor of the server computer 24 to, identify one or more potential navigation routes 26. The server computer 24 may identify potential navigation route 26 based on information received from the user device 34, based on a user request, based on calendar data, based on location data, based on information gleaned from emails, smartphone applications, websites, and the like, based on historical data, based on traffic data, etc., including conventional techniques to identify potential navigation routes 26 and user preferences and as discussed herein.

The server computer 24 may be programmed to collect one or more real-time images 28 from one or more remote vehicles 30, one or more infrastructure cameras, etc., positioned along the first potential navigation route 26, the second potential navigation route 26, etc. The server computer 24 may collect one or more real-time images 28 from one or more remote vehicles 30, one or more infrastructure cameras, etc., positioned along the potential navigation routes 26 in response to receiving the request for real-time images 28 from the user device computer 22.

For example, and without limitation, the server computer 24 may transmit a real-time image 28 request, i.e., a request for one or more real-time images 28, to one or more remote vehicles 30, one or more infrastructure cameras, etc., that are positioned along the potential navigation route 26 and are traveling and/or facing the direction of travel specified in the request for real-time images 28. To transmit the request, the server computer 24 may identify one or more remote vehicles 30, one or more infrastructure cameras, etc., positioned along the potential navigation route 26 and traveling and/or facing the specified direction of travel. The server computer 24 may transmit the real-time image 28 request to the identified one or more remote vehicles 30, one or more infrastructure cameras, etc., positioned along the potential navigation route 26, e.g., via the communication network 32.

The server computer 24 may identify one or more remote vehicles 30, one or more infrastructure cameras, etc., that are positioned along the potential navigation route 26 and are traveling and/or facing the specified direction of travel, for example and without limitation, based on information in a dynamic database stored in the server computer 24 and containing generally current location and direction of travel and/or facing direction information of a plurality of remote vehicles 30, one or more infrastructure cameras, etc. The server computer 24 may compare the potential navigation routes 26, including the direction of travel, specified in the request for real-time images 28 received from the user device computer 22 with the generally current location and direction of travel and/or facing direction information of a plurality of remote vehicles 30, one or more infrastructure cameras, etc., stored in the dynamic database to identify the one or more remote vehicles 30, one or more infrastructure cameras, etc., that are positioned along the potential navigation route 26 and are traveling and/or facing the specified direction of travel.

The server computer 24 may populate the dynamic database with generally current location and direction of travel information of a plurality of remote vehicles 30 based on information received from each of the remote vehicles 30. The received information may include, for example, a unique identifier specifying a certain remote vehicle 30, information regarding a generally current location of the certain remote vehicle 30, information regarding a direction of travel of the certain remote vehicle 30, information regarding a planned navigation route or the like for the certain remote vehicle 30, etc. The server computer 24 may receive such information from the remote vehicles 30 generally continuously, at intervals (e.g., every 20 seconds), sporadically, etc. The server computer 24 may populate the dynamic database with generally current location and direction of travel information of the plurality of remote vehicles 30 calculated based on information in the dynamic database, e.g., via extrapolation or the like, and/or based on information received from the remote vehicles 30, e.g., a planned navigation route for the remote vehicle 30.

The server computer 24 may receive real-time images 28 captured along the potential navigation route 26 from the remote vehicles 30, one or more infrastructure cameras, etc., e.g., via the communication network 32. The received real-time images 28 may include information specifying the location and the direction of travel and/or facing direction of the remote vehicle 30 or infrastructure camera capturing such image. The server computer 24 may be programmed to identify one or more objects in the received real-time images 28, e.g., as described above in for the user device computer 22. The one or more identified objects may relate to one or more of the user preferences. The server computer 24 may collect the information regarding the identified objects, e.g., as described above in for the user device computer 22. The server computer 24 may transmit the one or more captured real-time images 28 to the user device computer 22, e.g., via the communication network 32. The server computer 24 may transmit information specifying the identified objects and the information regarding the identified objects along with the real-time images 28 to the user device computer 22.

### Remote Vehicles

Remote vehicles 30 are vehicles separate from the user device 34, e.g., spaced from the user device 34 by a certain distance. For example, and without limitation, the remote vehicles 30 may be spaced from the user device 34 by a least a quarter-mile. The remote vehicles 30 may be cars, vans, sport utility vehicles, and/or any other type of vehicle.

Each remote vehicle 30 may include one or more cameras 42, a navigation unit 44, a communication unit 46, and a vehicle computer 48. The vehicle computer 48 may be in electronic communication with other components of the remote vehicle 30, e.g., the cameras 42, the communication unit 46, the navigation unit 44, etc. For example, the cameras 42, the communication unit 46, and/or the navigation unit 44 may be communicatively coupled to the vehicle computer 48, e.g., via wired and/or wireless electronic communication structure, including, but not limited to, a communication bus, a controller area network (CAN) bus, local interconnect network (LIN) bus, or the like.

The cameras 42 detect light and generate electronic information specifying images based on the detected light. Each camera 42 may include, for example, an active-pixel sensor (CMOS sensor) or the like. The cameras 42 may be oriented to capture images, e.g., still and/or video, from external of the remote vehicle 30. For example, and without limitation, the cameras 42 may be oriented to face forward, rearward, and/or laterally away from, and relative to, the remote vehicle 30 incorporating such cameras 42.

The navigation unit 44 determines a location of the remote vehicle 30, and may also determine a direction of travel of the remote vehicle 30, and a planned navigation route or the like for the remote vehicle 30. The navigation unit 44 may include a GPS device, electronic compass, or the like communicatively coupled to the vehicle computer 48. The navigation unit 44 is capable of generating location information and/or heading information indicative of a location of the remote vehicle 30 by receiving one or more GPS signals from one or more GPS satellites. The navigation unit 36 may be configured to generate heading information, for example, based on an electronic compass. The GPS signal communicated to the vehicle computer 48 may include location information comprising a National Marine Electronics Association (NMEA) message, a latitude and longitude data set, a street address, a name of a known location based on a location database, or the like. Additionally, the navigation unit 44 may be interchangeable with any other systems capable of generating an output indicative of a location. For example, a local positioning system that provides a location based on cellular signals and broadcast towers or a wireless signal detection device capable of triangulating a location by way of wireless signals received from one or more wireless signal antennas. The navigation unit 44 may include a digital map that includes geographical information. The digital map may be dynamic.

The communication unit 46 may communicatively couple the remote vehicle 30 to the communication network 32. The communications unit may include, for example, and without limitation, an antenna, a modem, LAN port, Wi-Fi card, WiMax card, mobile communications hardware, near-field communication hardware, satellite communication hardware, cellular network communication hardware, and/or any wired or wireless hardware for communicating with other networks and/or devices. The cellular network may include, for example, and without limitation, a Global System for Mobile Communications (GSM) network, a 3G Universal Mobile Telecommunications System (UMTS) network, a 4G Long Term Evolution (LTE) network, a 5G network, and the like.

The vehicle computer 48 may be any device or combination of components comprising a processor and non-transitory computer readable memory. The processor may be any device capable of executing the machine-readable instruction set stored in the non-transitory computer readable memory. Accordingly, the processor may be an electric controller, an integrated circuit, a microchip, a computer, or any other computing device.

The non-transitory computer readable memory may comprise RAM, ROM, flash memories, hard drives, or any non-transitory memory device capable of storing machine-readable instructions such that the machine-readable instructions can be accessed and executed by the processor. The machine-readable instruction set may comprise logic or algorithm(s) written in any programming language of any generation (e.g., 1GL, 2GL, 3GL, 4GL, or 5GL) such as, for example, machine language that may be directly executed by the processor 132, or assembly language, object-oriented programming (OOP), scripting languages, microcode, etc., that may be compiled or assembled into machine readable instructions and stored in the non-transitory computer readable memory. Alternatively, the machine-readable instruction set may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components.

The vehicle computer 48 may be programed to, i.e., the memory of the vehicle computer 48 may store machine-readable instructions executable by the processor of the vehicle computer 48 to, collect one or more real-time images 28. The real-time images 28 may be captured while navigating along the potential navigation route 26 in the direction of travel. For example, the vehicle computer 48 may command the cameras 42 to capture an image generally contemporaneously, i.e., within a minimum threshold amount of time, and in response to, receiving the real-time image 28 request from the server computer 24. As another example, the vehicle computer 48 may command the cameras 42 to capture an image at specified intervals, e.g., every 5 seconds.

The vehicle computer 48 may transmit the captured real-time images 28 to the server computer 24, e.g., via the communication network 32 and generally contemporaneously with capturing such images. The vehicle computer 48 may transmit information specifying a location and direction of travel of the remote vehicle 30 along with the captured real-time image.

### Process

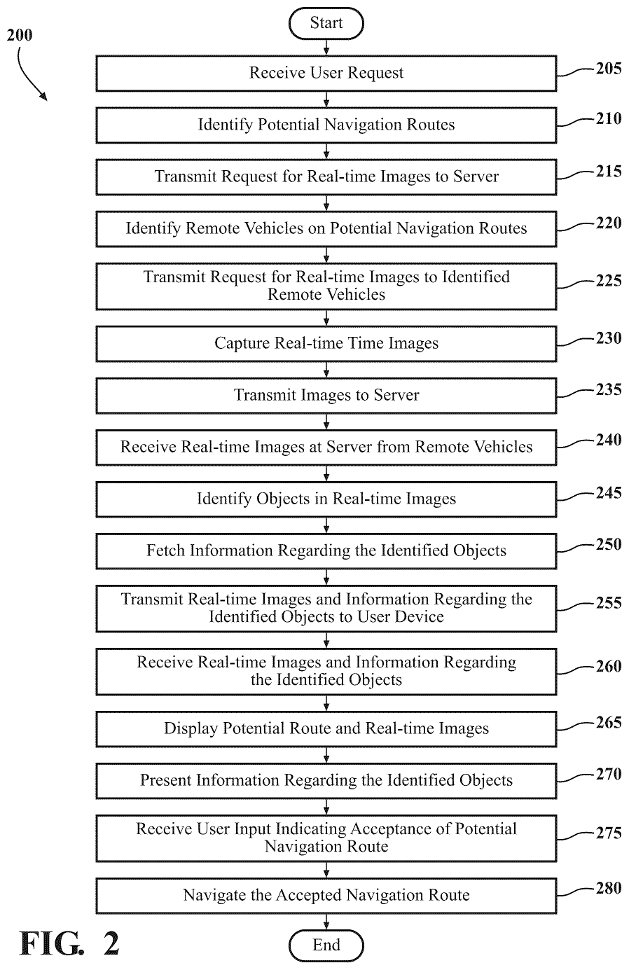

FIG. 2 is a process flow diagram illustrating an example process 200 for providing selection of a potential navigation route 26 by a user based on real-time images 28 captured along the potential navigation route 26. Executable machine-readable instructions for performing the steps of process 200 may be stored in memories of the user device computer 22 of the user device 34, the server computer 24, and/or the vehicle computers 48 of the remote vehicles 30, one or more infrastructure cameras, etc.

The process 200 begins at a block 205 where a user request is received by the user device 34. For example, a user may provide the user request as an input to the user interface 40 and/or otherwise as described herein.

Next, at a block 210 the user device 34 identifies one or more potential navigation routes 26, e.g., in response to and based on the user request received at the block 205. The user device 34 may identify the one or more potential navigation routes 26 in cooperation with the server computer 24 and/or otherwise as described herein.

Next, at a block 215 the user device 34 transmits, to the server computer 24, a request for real-times images 28 captured along the one or more potential navigation routes 26, e.g., via the communication network 32 and as described herein.

At a block 220 the server computer 24 identifies one or more remote vehicles 30, one or more infrastructure cameras, etc., located along the one or more potential navigation routes 26 and traveling and/or facing the direction of travel specified in the request received at the block 215, e.g., as described herein.

Next, at a block 225 the server computer 24 transmits a request for real-time images 28 to the one or more remote vehicles 30, one or more infrastructure cameras, etc., located along the one or more potential navigation routes 26 and traveling and/or facing the direction of travel as identified at the block 220, e.g., via the communication network 32 and as described herein.

Next, at a block 230, one or more of the remote vehicles 30, one or more infrastructure cameras, etc., located along the one or more potential navigation routes 26 and traveling and/or facing the direction of travel capture real-time images 28, e.g., in response to receiving the request for real-time images 28 transmitted at the block 225 and as described herein.

At a block 235 one or more of the remote vehicles 30, one or more infrastructure cameras, etc., transmit the real-time images 28 captured at the block 230 to the server computer 24, e.g., via the communication network 32.

At a block 240 the server computer 24 receives the real-time images 28 captured by one or more remote vehicles 30, one or more infrastructure cameras, etc., positioned along the potential navigation route 26 and transmitted at the block 235, e.g., via the communication network 32.

At a block 245 the server computer 24 identifies objects in the real-time images 28 received at the block 245, e.g., as described herein.

At a block 250 the server computer 24 fetches or otherwise collects information regarding the objects identified at the block 245, e.g., as described herein.

At a block 255 the server computer 24 transmits the real-time images 28 received at the block 240 and the information regarding the objects collected at the block 250 to the user device 34, e.g., via the communication network 32.

At a block 260 the user device 34 receives the real-time images 28 and the information regarding the objects transmitted at the block 255.

Next, at a block 265 the user device 34 displays the real-time images 28 received at the block 260 along with the one or more potential navigation routes 26 along which such real-time images 28 were captured, e.g., as shown in FIG. 3 and as discussed herein.

At a block 270 the user device 34 presents the information regarding the objects received at the block 260, e.g., concurrent with displaying the real-time images 28 at the block 265 and as discussed herein.

Next, at a block 275 the user device 34 receives a user input indicating acceptance of the potential navigation route 26 displayed at the block 265, or a user input indicating acceptance of a specific one of the potential navigation routes 26 displayed at the block 265, e.g., via the user interface 40 and as described herein.

Next, at a block 280, and in response to receiving acceptance of the potential navigation route 26 or acceptance of a specific one or the potential navigation routes 26, the user device 34 navigates the accepted route, e.g., as described herein.

From the above, it is to be appreciated that described herein is a system and method for providing real-time route views along a potential navigation route by identifying the potential navigation route and requesting, receiving, and displaying one or more real-time images captured, along the potential navigation route.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system for providing real-time route views, the system comprising:
a user device computer;
a server computer in electronic communication with the user device computer;
the user device computer programmed to:
identify a potential navigation route;
transmit a request for real-time images captured along the potential navigation route to the server computer;
receive one or more real-time images from the server computer; and
display the one or more received real-time images; and
the server computer programmed to:
in response to receiving the request for real-time images captured along the potential navigation route from the user device computer, collect one or more real-time images along the potential navigation route; and
transmit the one or more captured real-time images to the user device computer.

2. The system of claim 1, wherein the user device computer is further programmed to identify one or more objects in the real-time images, and to present information regarding the identified objects.

3. The system of claim 2, wherein the user device computer is further programmed to audibly present the information regarding the identified object concurrent with displaying the one or more received real-time images.

4. The system of claim 1, wherein the user device computer is further programmed to, after displaying the one or more received real-time images, receive a user input indicating acceptance of the potential navigation route, and in response to receiving the user input, navigate the accepted navigation route.

5. The system of claim 1, wherein the user device computer is programed to identify a second potential navigation route, transmit a request for real-time images along the second potential navigation route, receive and display one or more real-time images captured along the second potential navigation route, and request selection of the potential navigation route or the second potential navigation route.

6. The system of claim 1, wherein the server computer is further programed to identify one or more remote vehicles positioned along the potential navigation route, transmit a real-time image request to the identified one or more remote vehicles positioned along the potential navigation route, and to receive real-time images from the identified one or more remote vehicles positioned along the potential navigation route.

7. The system of claim 1, wherein the potential navigation route includes information specifying a direction of travel, and wherein the request for real-time images captured along the potential navigation route includes the direction of travel.

8. The system of claim 7, wherein the captured one or more real-time images are captured from one or more remote vehicles navigating along the potential navigation route in the direction of travel.

9. A user device for providing real-time route views, the user device comprising a user device computer having a processor and a memory storing machine-readable instructions executable by the processor to:
identify a potential navigation route;
transmit a request for real-time images captured along the potential navigation route;
receive one or more real-time images captured along the potential navigation route; and
display the one or more received real-time images.

10. The user device of claim 9, wherein the machine-readable instructions include instructions to identify one or more objects in the real-time images, and to present information regarding the one or more identified objects.

11. The user device of claim 10, wherein the machine-readable instructions include instructions to audibly present the information regarding the identified object concurrent with displaying the one or more received real-time images.

12. The user device of claim 10, wherein the machine-readable instructions include instructions to identify the potential navigation route based on a user preference, and wherein the one or more identified objects are related to the user preference.

13. The user device of claim 9, wherein the machine-readable instructions include instructions to, after displaying the one or more received real-time images, receive a user input indicating acceptance of the potential navigation route, and in response to receiving the user input, navigate the accepted navigation route.

14. The user device of claim 9, wherein the machine-readable instructions include instructions to identify a second potential navigation route, transmit a request for real-time images along the second potential navigation route, receive and display one or more real-time images captured along the second potential navigation route, and request selection of the potential navigation route or the second potential navigation route.

15. The user device of claim 9, wherein the potential navigation route includes information specifying a direction of travel, and wherein the received one or more real-time images are captured from one or more remote vehicles navigating along the potential navigation route in the direction of travel.

16. A method for providing real-time route views, the method comprising:
identifying a potential navigation route;
transmitting a request for real-time images captured along the potential navigation route;
receiving one or more real-time images captured along the potential navigation route; and
displaying the one or more received real-time images.

17. The method of claim 16, further comprising, in response to receiving the request for real-time images captured along the potential navigation route, capturing one or more real-time images along the potential navigation route, and transmitting the one or more captured real-time images.

18. The method of claim 17, wherein the request for real-time images captured along the potential navigation route includes a direction of travel, and wherein the one or more real-time images are captured from one or more remote vehicles navigating along the potential navigation route in the direction of travel.

19. The method of claim 16, further comprising identifying one or more objects in the real-time images, and presenting information regarding the identified objects concurrent with displaying the one or more received real-time images.

20. The method of claim 16, further comprising identifying a second potential navigation route, transmitting a request for real-time images along the second potential navigation route, receiving and displaying one or more real-time images captured along the second potential navigation route, and requesting selection of the potential navigation route or the second potential navigation route.
